(19) United States
(12) Patent Application Publication
(10) Pub. No.: US 2014/0191982 A1
(43) Pub. Date: Jul. 10, 2014

(54) Mobile Device, Control Apparatus and Control Method of Controlling a Remote Device via A Touch Screen Mobile Device

(71) Applicant: MAXWAY ELECTRONICS CO., LTD., Shenzhen (CN)

(72) Inventor: MIN GUO, Shenzhen (CN)

(73) Assignee: MAXWAY ELECTRONICS CO., LTD., Shenzhen (CN)

(21) Appl. No.: 13/864,166

(22) Filed: Apr. 16, 2013

(30) Foreign Application Priority Data
Jan. 10, 2013 (CN) 201310008563.0

(51) Int. Cl. G06F 3/041

(52) U.S. Cl. CPC G06F 3/0412
USPC 345/173

(57) ABSTRACT

The invention provides a method of controlling a remote device via a mobile device, and provides corresponding control unit and mobile device. The method includes: displaying a control page of a number of controllers on the touch screen while the mobile device switching from hibernate state to working state, and the interface of control page is in front of the lock screen of the touch screen mobile device; and sending a corresponding control command to a remote device according to the control mode of the controller, while a user simulating the operation of one of the controllers. By implementing the invention, when a mobile device switches from hibernate state to working state, a control page of a number of controllers is displayed in the touch screen and above the lock screen. As such, the user can directly simulate the controllers to control the remote device. The user does not need to unlock the mobile device, therefore, the user's real time needs are meet.

### CROSS REFERENCE TO RELATED APPLICATIONS

This non-provisional patent application claims priority under 35 U.S.C. §119(a) from Patent Application No. 201310008563.0 filed in The People's Republic of China on Jan. 10, 2013.

### FIELD OF THE INVENTION

This invention generally relates to wireless communication, and particularly to a method of controlling a remote device via the mobile device, and relates to control unit and mobile device.

### BACKGROUND OF THE INVENTION

Touch screen devices are more and more popular. Using touch devices such as mobile phones, PDAs (Personal Digital Assistant) to control other devices in networks are becoming common. For example, the mouse's function and touchpad's function could be remotely accomplished. However, most mobile devices have the function of lock screen. Users need to unlock the screen to accomplish the remote mouse or remote control, which does not meet the uses' real time needs.

### SUMMARY OF THE INVENTION

The present invention provides a method of controlling a remote device via a mobile device, and provides a mobile device and its control unit. A control page of a number of controllers are displayed above lock screen of the mobile device, as such, user's real time needs are met.

Accordingly, in one aspect thereof, the present invention provides a method of controlling a remote device via a touch screen mobile device. The method comprises a step of displaying a control page of a number of controllers on the touch screen while the mobile device switching from hibernate state to working state and the interface of control page is in front of the lock screen of the touch screen mobile device. The method further comprises a step of sending a corresponding control command to a remote device according to the control mode of the controller, while a user simulating the operation of one of the controllers.

In another aspect thereof, the present invention provides an apparatus for controlling a remote device. The apparatus may be a control unit of a mobile device. The control unit comprises a display module, a process module and a sending module. The control unit is configured to display a control page of a number of controllers on the touch screen while the mobile device switching from hibernate state to working state, and the interface of control page is in front of the lock screen of the touch screen mobile device. The control unit is further configured to send a corresponding control command to a remote device according to the control mode of the controller, while a user simulates the operation of one of the controllers.

In yet another aspect thereof, the present invention provides a mobile device having a touch screen, wherein the mobile device comprises a display module, a process module and a sending module. The mobile device is configured to display a control page of a number of controllers on the touch screen while the mobile device switches from hibernate state to working state, and the interface of control page is in front of the lock screen of the touch screen mobile device. The mobile device is further configured to send a corresponding control command to a remote device according to the control mode of the controller while a user simulates the operation of one of the controllers.

By implementing the invention, when a mobile device switches from hibernate state to working state, a control page of a number of controllers is displayed in the touch screen and above the lock screen. As such, the user can directly simulates the controllers to control the remote device. The user does not need to unlock the mobile device, therefore, the user's real time needs are meet. When the user wants to perform other functions of the mobile device, the user can just exit the control page and return to the lock screen, as such, user's security demand is retained.

### BRIEF DESCRIPTION OF THE DRAWINGS

Various embodiments of the present invention are described, by way of example only, with reference to the drawings, in which identical or related structures, elements, or parts may be labeled with the same reference numerals throughout the figures. Dimensions of components and features shown in the figures are generally chosen for convenience and clarity of presentation and are not necessarily to scale.

FIG. 1 is a flow chart of the method of controlling a remote device via a touch screen device according to an exemplary embodiment of the present invention;

FIG. 2 is a schematic block diagram of a control unit of a touch screen device to control a remote device according to an exemplary embodiment of the present invention; and

FIG. 3 is a schematic block diagram of a touch screen device according to an exemplary embodiment of the present invention.

### DETAILED DESCRIPTION OF VARIOUS EMBODIMENTS

Various embodiments of the present invention are described, by way of example only, with reference to the drawings.

Referring to FIG. 1, according to the present invention, a method of controlling a remote device via a touch screen mobile device comprises the following steps.

At S101, a mobile device is switched from hibernate state to working state.

At S102, a control page of a number of controllers is displayed on a touch screen of the mobile device; the interface of control page is in front of the lock screen of the touch screen and is available for user's operating to control a remote device.

At S103, a corresponding control command is sent to the remote device according to the control mode of the controller, while the user simulates the operation of one of the controllers.

As such, the user can directly simulate the number of controllers to control the remote device. The user does not need to unlock the mobile device to accomplish the control, which meets the user's real time needs. When the user wants to perform other function of the mobile device, the user can just exit the control page to return to the lock screen of the mobile device. The configuration retains user's security demand.

Preferably, when the mobile device is switched from hibernate state to working state, user-friendly control options are displayed in the touch screen for the user's selecting operation. When selected by the user, the mobile device displays a control page of a number of controllers in the touch screen, to meet users' needs.

When the user exits the control page of the number of controllers, the control page is cleared and the screen is locked. The user can perform the mobile device's other function by unlocking the mobile device. An exit key could be configured in the touch screen for the user to perform the exit operation.

The number of controllers may comprise a mouse, a keyboard, a remote controller or a touchpad. The remote device could be a home media device. The mobile device could be a mobile phone, a PAD and other touch screen devices.

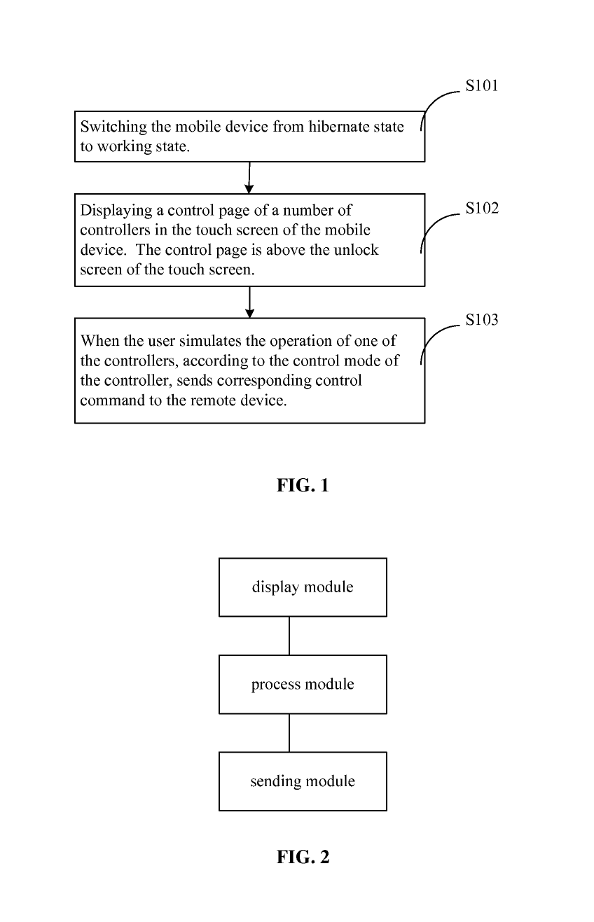

Corresponding to the method of controlling a remote device via a mobile device, the present invention also provides a control unit of a touch screen mobile device to control the remote device. Referring to FIG. 2, the control unit comprises a display module, a process module and a sending module.

When the mobile device switches from hibernate state to working state, the display module displays the control page of a number of controllers in the touch screen of the mobile device. The control page is above lock screen of the mobile device.

When the user simulates the operation of one of the controllers, according to the control mode of the controller, the process module sends corresponding control command to the remote device via the sending module.

Preferably, when the mobile device switches from the hibernate state to working state, the display module displays control options in the touch screen for the user's selecting operation. When the user selects, a control page of a number of controllers is displayed on the touch screen of the mobile device. When the user exits the control page, the control page is cleared and the screen is locked.

The controller could be a mouse, a keyboard, a remote controller or a touchpad. The remote device could be a home media device. The mobile device could be a mobile phone, a PAD or other touch screen devices.

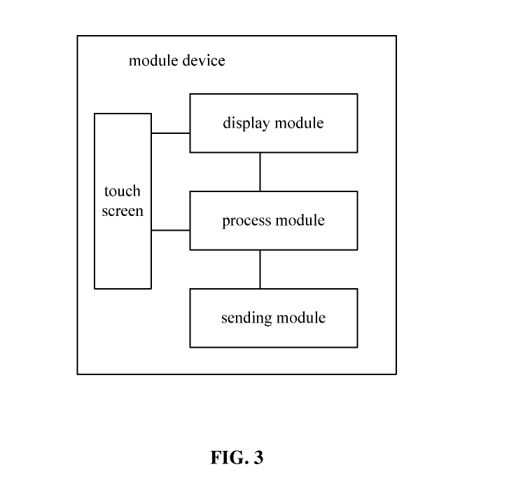

Referring to FIG. 3, the present invention also provides a mobile device having a touch screen. The mobile device comprises a display module, a process module connected to the display module, and a sending module connected to the process module. The touch screen connects to the display module and the process module.

When the mobile device switches from hibernate state to working state, the display module displays the control page of a number of controllers in the touch screen of the mobile device. The control page is above lock screen of the mobile device.

When the user simulates the operation of one of the controllers, according to the control mode of the controller, the process module sends corresponding control command to the remote device via the sending module.

Preferably, when the mobile device switches from the hibernate state to working state, the display module displays control options on the touch screen for the user's selecting operation. When the user selects, a control page of a number of controllers is displayed in the touch screen of the mobile device. When the user exits the control page, the control page is cleared and the screen is locked.

The controller could be a mouse, a keyboard, a remote controller or a touchpad. The remote device could be a home media device. The mobile device could be a mobile phone, a PAD or other touch screen devices.

Although the invention is described with reference to one or more preferred embodiments, it should be appreciated by those skilled in the art that various modifications are possible. Therefore, the scope of the invention is to be determined by reference to the claims that follow.

In the description and claims of the present application, each of the verbs “comprise”, “include”, “contain” and “have”, and variations thereof, are used in an inclusive sense, to specify the presence of the stated item but not to exclude the presence of additional items.

What is claimed is:

1. A method of controlling a remote device via a touch screen mobile device, comprises:
displaying a control page of a number of controllers on the touch screen while the mobile device switching from hibernate state to working state, and the interface of control page is in front of the lock screen of the touch screen mobile device; and
sending a corresponding control command to a remote device according to the control mode of the controller, while a user simulating the operation of one of the controllers.

2. The method of claim 1, wherein, displaying control options on the touch screen for user's selecting operation while the mobile device switching from hibernate state to working state; during the selecting, displaying the control page of a number of controllers on the touch screen.

3. The method of claim 1, wherein, clearing the control page and locking the touch screen while exiting the control page of a number of controllers.

4. The method of claim 1, wherein the controller is selected from the group consisting of mouse, keyboard, remote controller and touchpad; the remote device is a home media device.

5. A control unit of a touch screen mobile device for controlling a remote device, comprises a display module, a process module and a sending module, wherein,
the control unit displaying a control page of a number of controllers on the touch screen while the mobile device switching from hibernate state to working state, and the interface of control page is in front of the lock screen of the touch screen mobile device; and
sending a corresponding control command to a remote device according to the control mode of the controller, while a user simulating the operation of one of the controllers.

6. The control unit of claim 5, wherein,
the control unit displaying control options on the touch screen for user's selecting operation while the mobile device switching from hibernate state to working state; during the selecting, displaying the control page of a number of controllers on the touch screen; and
clearing the control page and locking the touch screen while exiting the control page of a number of controllers.

7. The method of claim 1, wherein the controller is selected from the group consisting of mouse, keyboard, remote controller and touchpad; the remote device is a home media device.

8. A mobile device having a touch screen, wherein the mobile device comprises a display module, a process module and a sending module, wherein:
the mobile device displaying a control page of a number of controllers on the touch screen while the mobile device switching from hibernate state to working state, and the interface of control page is in front of the lock screen of the touch screen mobile device; and
sending a corresponding control command to a remote device according to the control mode of the controller, while a user simulating the operation of one of the controllers.

9. The mobile device of claim 8, wherein:
the mobile device displaying control options on the touch screen for user's selecting operation while the mobile device switching from hibernate state to working state; during the selecting, displaying the control page of a number of controllers on the touch screen; and
clearing the control page and locking the touch screen while exiting the control page of a number of controllers.

10. The mobile device of claim 8, wherein the controller is selected from the group consisting of mouse, keyboard, remote controller and touchpad; the remote device is a home media device.
